(19) United States
(12) Patent Application Publication
(10) Pub. No.: US 2006/0168016 A1
(43) Pub. Date: Jul. 27, 2006

(54) E-mail

(76) Inventor: Michael Coyle Barrett, Austin, TX (US)

Correspondence Address: Michael C. Barrett, 4700 Hilwin Circle, Austin, TX, 78756, US

(21) Appl. No.: 11/000,149

(22) Filed: Nov. 30, 2004

(51) Int. Cl. G06F 15/16

(52) U.S. Cl. 709/206

(57) ABSTRACT

Improved e-mail functionality. In a first general respect, the invention relates to the ability to co-author an e-mail. For example, an e-mail can be attributed to several senders in the same or similar way that conventional technology attributes e-mails to be from a single user. In a second general respect, the invention relates to the ability to customize the distribution of attachments between recipients of a single e-mail message. For example, one can send an e-mail to several recipients and choose which of those recipients should receive which of the attachments. In this way, e-mail can mimic the practice of letters—copying someone “without enclosures.” Moreover, certain attachments can be included for certain recipients while excluding others.

### BACKGROUND OF THE INVENTION

1. Field of the Invention

The present invention generally relates to electronic mail (e-mail). More particularly, in a first general respect, the invention relates to the ability to co-author an e-mail and to identify a co-authored e-mail. In a second general respect, the invention relates to the ability to customize the distribution of attachments between recipients of a single e-mail message.

2. Background

(a) Co-Authoring E-mails

Conventional e-mail applications only allow a single user to send a message to one or more recipients. A single e-mail address is identified as the source of an e-mail to one or more recipient e-mail addresses. To send an e-mail to more than one recipient, recipient e-mail addresses are entered into a “To,” “Cc,” and/or “Bcc” field. Recipients can see the names, short-hand identifiers, and/or e-mail addresses of other recipients who were listed in the “To” and “Cc” fields.

Conventional e-mail applications do not allow multiple users to co-author a single e-mail, or to identify a message as being sent by more than one user. Using conventional e-mail applications, a single user (User A) sends a message and, within the body of the message, may state something like, “User B agrees with this message” or, “This is being sent by User A and User B.” Alternatively, a signature line or an e-mail closing may indicate that User B had some say in the message or should also be considered an author/sender: “Regards, User A and User B.” In these situations, however, it is only after the e-mail is opened or otherwise read that a recipient would note that the message is meant to be attributed to more than one user. Prior to opening, the e-mail is listed in the recipient's Inbox or equivalent as having been sent by User A alone.

What would be more useful, however, would be techniques, currently absent from the art, so that User B could be identified in the same or similar manner as User A as a sender of the message. Further, in other embodiments, it would be useful if User B not only could be identified along with User A as a sender, but also if User B could substantively contribute to the content of the message prior to sending. In short, in either or both cases, it would be useful if “co-authored” e-mails were possible.

(b) Attachments

Conventional e-mail applications allow a user to send a message to one or more recipients, the message including one or more file attachments. Perhaps due to the ease of sending attachments, some e-mail users abuse this ability and attach large files or irrelevant files to e-mails without regard to the consequences. If a large attachment is sent to a User A, who has a slow, dial-up connection, his or her computer can be tied up for a significant amount of time simply downloading the attachment. Worse, often times User A is just a recipient by way of a “Cc” or “Bcc” field, and User A may not have needed to have the actual attachment—many times, just having seen the message itself would have sufficed. By collecting scores of unnecessary attachments, users more quickly fill their storage media or, alternatively, are forced to spend time deleting messages to save space. Other times, although a message is intended for several people, an associated attachment may be intended only for a subset of those people.

The following example assumes conventional e-mail technology. User A can send a message to Users B, C, D, E, F by putting those users in the “To” field and/or “Cc” or “Bcc” fields. That message can include Attachments 1, 2, and 3. Currently, there is no way to send the message and dictate that Users E and F should not get any of the attachments. Likewise, there is no way to send the message so that User B only gets Attachment 1, and User E only gets attachments 2 and 3. In short, there is no way to customize the distribution of attachments between recipients of a single e-mail message.

To customize distribution of attachments using today's technology, a user has to send separate e-mail messages. For example, a user may compose a message and include attachments meant for all the recipients. The e-mail is then sent. Then, the user would cut-and-paste the message, not include attachments, and address the e-mail to different recipients who do not need the attachments. The second e-mail is then sent. Thus, the trouble of composing two or more e-mails is necessary to complete what would preferably be done in a single e-mail. A similar procedure would have to be followed if the user wanted to include different attachments for different recipients. Custom distribution of attachments among varied recipients would therefore be desirable.

Referenced shortcomings outlined above are not intended to be exhaustive. Rather, they are among many that tend to impair the effectiveness of conventional e-mail applications. Those mentioned here, however, are sufficient to demonstrate that a significant need exists for the techniques described and claimed in this document.

### SUMMARY OF THE INVENTION

Particular shortcomings of the prior art are reduced or eliminated by the techniques discussed in this document.

In one respect, the invention involves an e-mail method comprising providing a header field to identify a co-author of an e-mail message, the co-author being identified in a header as an additional sender of the e-mail message upon receipt.

In another respect, the invention involves an e-mail method, where an e-mail recipient is identified in a first header field. An e-mail co-author is identified in a second header field. An e-mail message is generated. The e-mail message is sent first to the co-author and then to the recipient. The co-author is identified in a header as an additional sender of the e-mail message upon receipt.

In other respects, the method may also include allowing the co-author to approve the e-mail message prior to sending to the recipient. The co-author may be allowed to revise the e-mail message prior to sending to the recipient. The author may be allowed to approve revisions of the co-author prior to sending to the recipient.

Any of the methods of this disclosure, including those above, may be implemented in a computer readable medium. For example, one may use a computer readable medium including computer executable instructions for providing a header field to identify a co-author of an e-mail message, the co-author being identified in a header as an additional sender of the e-mail message upon receipt.

In another respect, the invention involves an e-mail method, where a single e-mail message is generated including an attachment. A first e-mail recipient is identified. A second e-mail recipient is identified. It is indicated that the attachment should not be delivered to the second e-mail recipient. The single e-mail message is sent to the first and second e-mail recipients, the attachment being delivered to the first e-mail recipient but not to the second e-mail recipient.

In other respects, the second e-mail recipient may be identified in a “Cc” or “Bcc” header field. The attachment may be removed from the e-mail intended for the second e-mail recipient prior to being sent from a sender. The attachment may be removed from the e-mail intended for the second e-mail recipient after being sent from a sender but before being opened by the second e-mail recipient. The method may also include indicating to the second e-mail recipient that an attachment was not delivered to him or her. The method may also include indicating to the first e-mail recipient that an attachment was not delivered to the second e-mail recipient.

In another respect, the invention involves any e-mail method that dictates the distribution of attachments among recipients of a single e-mail message to be delivered to those recipients.

Any of the methods of this disclosure, including those above, may be implemented in a computer readable medium. For example, one may use a computer readable medium including computer executable instructions for generating a single e-mail message including an attachment; identifying a first e-mail recipient; identifying a second e-mail recipient; indicating that the attachment should not be delivered to the second e-mail recipient; and sending the single e-mail message to the first and second e-mail recipients, the attachment being delivered to the first e-mail recipient but not to the second e-mail recipient.

As used here, a “co-authored” e-mail simply connotes an e-mail message that indicates more than one sender someplace other than in the body of the message itself (e.g., in a “co-authored” e-mail, more than one sender is indicated in header field(s)). It does not necessarily connote that more than one person contributed content to the message. In different embodiments, that may be the case, but it is not required. In fact, in some embodiments, one person may have drafted the complete message but the message could be identified as having one or more co-authors so that recipients would attribute the message to more than one person instead of an individual sender. In different embodiments, a recipient may be notified if a co-author actually contributed content and/or edited the message.

As used here, an e-mail “message” need not refer to the attachments. In preferred embodiments, the “message” is the text or other content within the body of an e-mail (e.g., whatever does not constitute an attachment). Thus, if this disclosure is describing an e-mail having attachments, one way (but not the only way) to describe the situation would be to say that the e-mail includes (a) an e-mail message and (b) attachments.

As used here, “a” and “an” shall not be interpreted as meaning “one” unless the context necessarily and absolutely requires such interpretation.

As used here, the introductions “for example” and its shorthand designation “e.g.” indicate examples only and should not be interpreted as requirements; rather, they provide one or more possibilities.

As used here, reference to an “embodiment” reflects that the description is directed towards an example technique and should not be taken as the only technique, the required technique, or the technique that limits the claims. Identifying an “embodiment” as “preferred,” should not be taken any differently.

Other features and associated advantages will become apparent with reference to the following detailed description of specific embodiments in connection with the accompanying drawings.

### BRIEF DESCRIPTION OF THE DRAWINGS

The techniques of this disclosure may be better understood by reference to one or more of these drawings in combination with the detailed description of example, non-limiting embodiments presented here.

FIGS. 1A-1C are diagrams illustrating conventional technology, which highlight some deficiencies in the state of the art.

FIGS. 2A-2D are diagrams in accordance with embodiments of the present disclosure dealing with co-authored e-mails.

FIGS. 3A-3F are diagrams in accordance with embodiments of the present disclosure dealing with the management of e-mail attachments.

### DESCRIPTION OF ILLUSTRATIVE EMBODIMENTS

Techniques of this disclosure aim to address or eliminate shortcomings in e-mail technology, and particularly shortcomings that lead to the inability of users to (a) send an e-mail message and attribute it to more than one user and (b) customize the distribution of attachments for an e-mail.

The description throughout this entire disclosure is directed to example embodiments. Readers should note that the claims at the end of this disclosure, not the description, define the legal scope of the invention in accordance with existing patent law. Claims can be, and often are, broader in their coverage than particular embodiments described. For example, if a claim does not list a particular step or feature discussed in the description, the invention defined by the claim does not require that step or feature.

Use of the phrase “comprising” in the claims signals an open-ended claim, in which extra steps do not avoid infringement. If the claims comprise steps or features A, B, and C, then that claim would cover the situation in which A, B, C, and D are practiced. Put yet another way, extra steps or features do not avoid infringement.

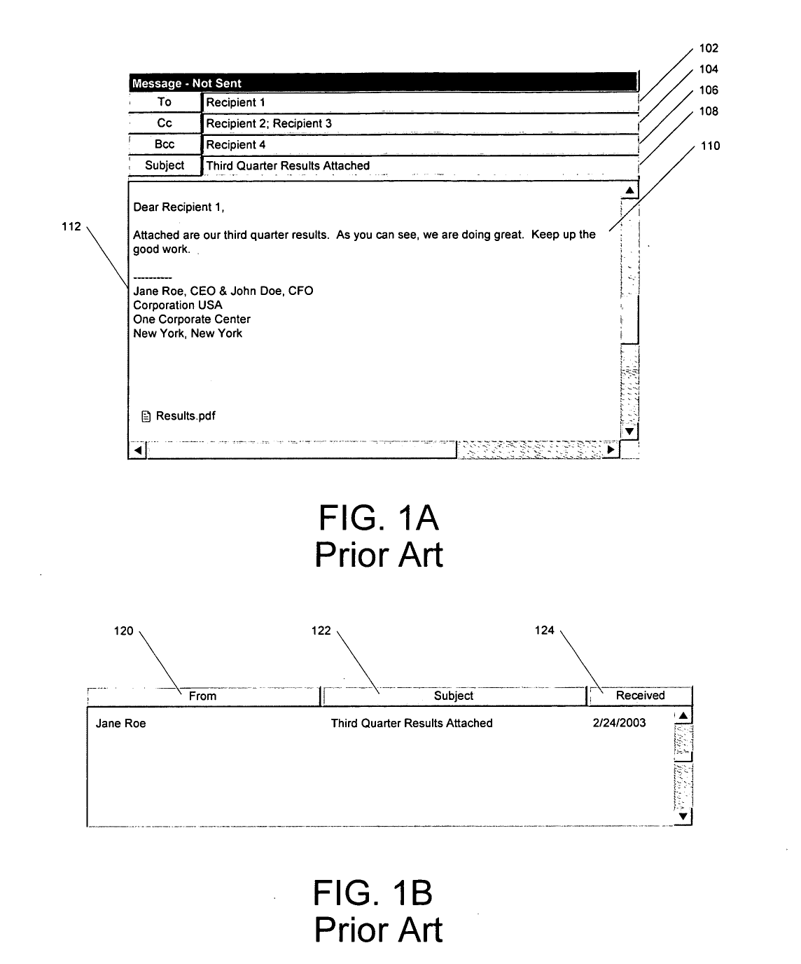

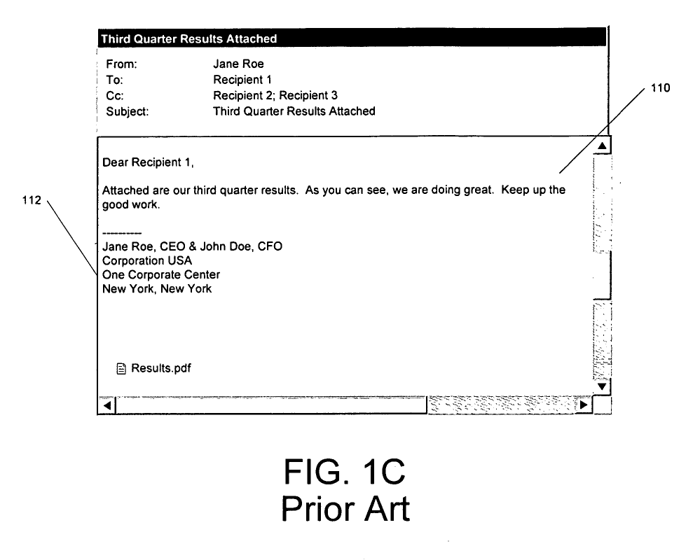

Reference to FIGS. 1A-1C reinforces what is outlined in the Background section. In FIG. 1A, CEO Jane Roe wants to send an e-mail to several people outlining third quarter financial results. She would like to attribute the message as also coming from CFO John Doe. The message, with an attachment, is being sent to Recipient 1. Recipients 2 and 3 are being cc'd. Recipient 4 is being bcc'd. Recipient 1's e-mail address is entered into the “To” header field 102. Recipient 2 and 3's e-mail addresses are entered into “Cc” header field 104. Recipient 4's e-mail address is entered into the “Bcc” header field 106. The e-mail subject is entered into the “Subject” header field 108. Using conventional e-mail applications, a way in which Jane Roe may indicate that the message 110 is meant to be coming from her and John Doe is to do what is shown in FIG. 1A—include a text or graphic signature 112 listing her and John Doe.

FIG. 1B illustrates shortcomings in this common technique. When a recipient gets the e-mail, it appears that it is only coming from Jane Roe. FIG. 1B illustrates what a recipient may see in his or her “Inbox” upon receiving the message. The “From” header 120 indicates Jane Roe's name only. The “Subject” header 122 and “Received” header 124 note the subject line and received date, respectively. When Jane Roe looks in her “Sent” e-mail folder, she may see something similar to what is shown in FIG. 1B; again, it is not apparent that the message was meant to be attributed to more than one sender.

FIG. 1C shows that recipients (and Jane Roe herself if she is reading from her “Sent” folder or another folder) learn that the e-mail message was meant to be from more than one user only when message 110 is opened and read, particularly when signature 112 is read. FIG. 1C illustrates what may be seen when the message is “double-clicked” from an “Inbox” or otherwise opened for viewing. The view of FIG. 1C could be provided, in whole or in part, through the use of a preview pane in some conventional applications.

Disadvantageously, once the message is opened, some recipients may not even notice that the message is meant to be from more than one person. Only when one reaches the end of the message is it revealed that the message is really a group message, which may signal greater importance, a joint effort, or a host of other indications. Additionally, because of the drawbacks of conventional technology, recipients may doubt that John Doe had any real role in the e-mail. These, and other, shortcomings can be overcome with use of techniques described here.

FIGS. 1A-1C also highlight shortcomings associated with conventional technology's inability to distribute attachments. There is no way using conventional technology to dictate that Recipient 1 should receive the attachment (“Results.pdf”) while Recipients 2 and 3 should only receive the e-mail message itself. If some custom distribution of attachments was desired, Jane Roe and/or John Doe would most likely have to copy the message and send an additional e-mail message without the attachment to those recipients who do not need it (or should not get it for security or other reasons). This solution is not acceptable for many reasons. In addition to having to create two e-mails instead of one (taking more time), the sending of multiple e-mails deprives recipients of the knowledge of who else is receiving the e-mail. In other words, if Recipient 1 receives the e-mail with the attachment but notes that Recipients 2 and 3 are left off, Recipient 1 may forward the message to Recipients 2 and 3, not realizing that they already received a separate, identical e-mail except for the lack of the attachment.

Co-Authored E-Mails:

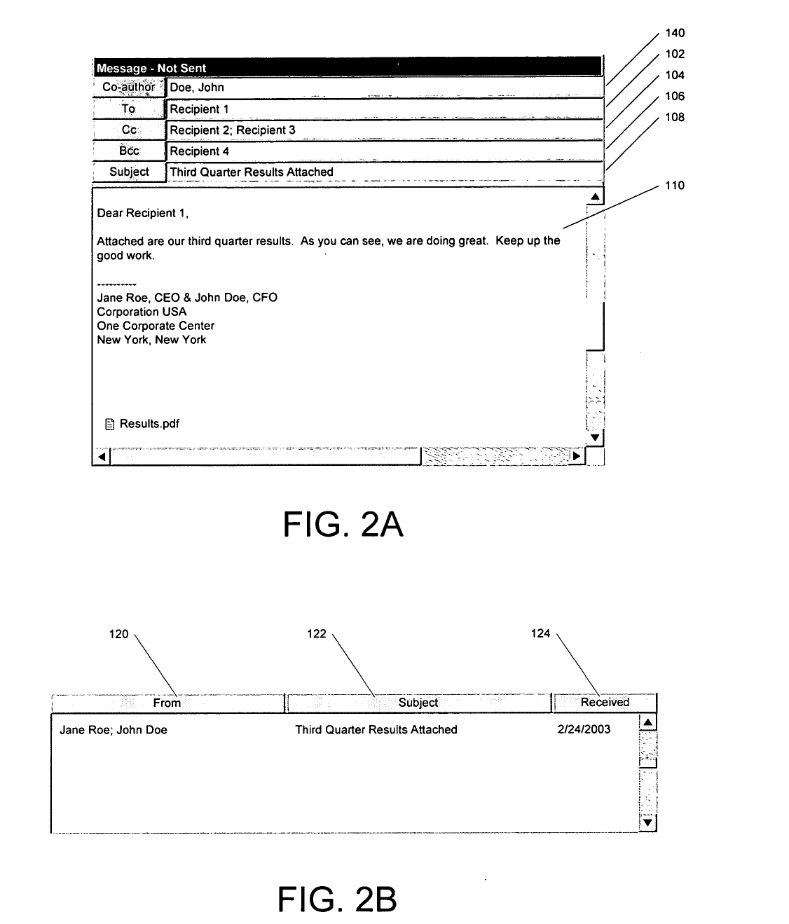

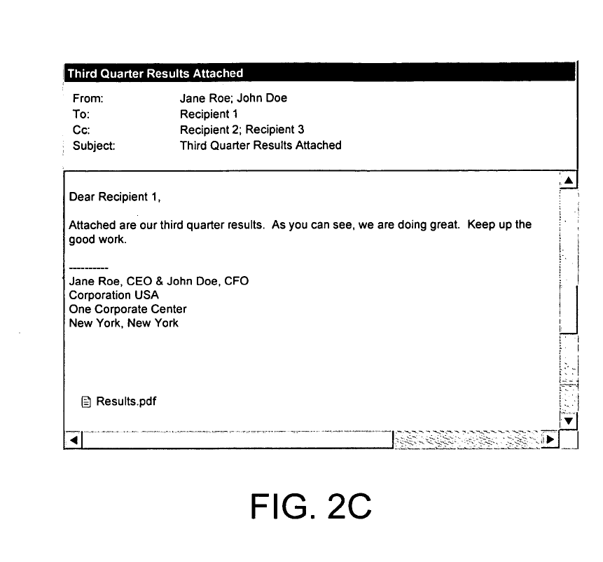

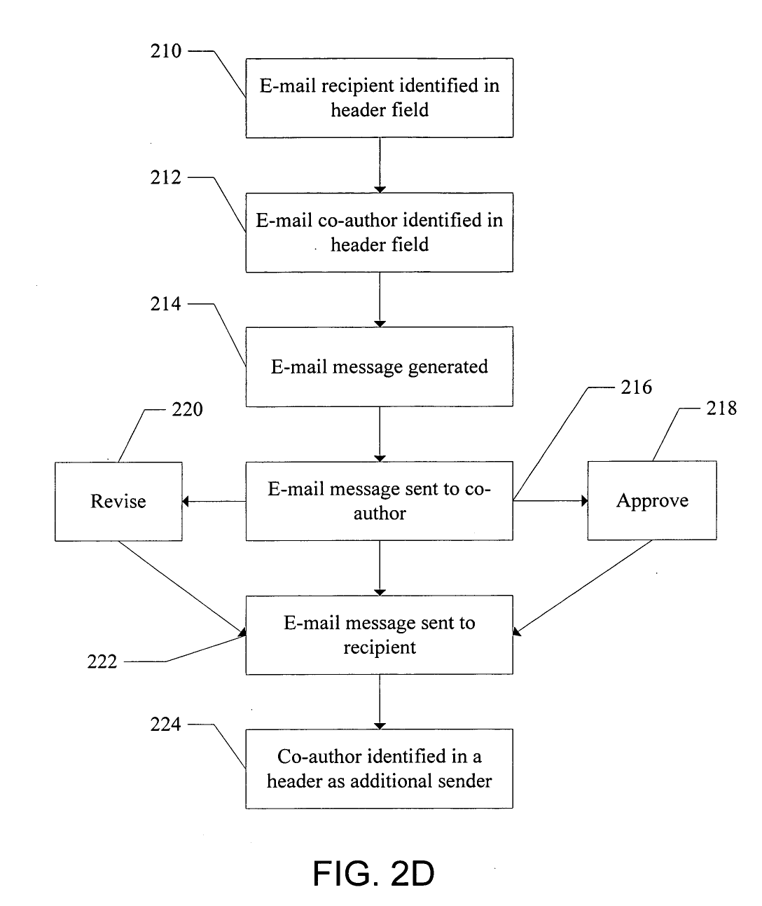

FIGS. 2A-2D are diagrams in accordance with embodiments of the present disclosure dealing with co-authored e-mails.

In FIG. 2A, a header field 140 is provided to identify a co-author. As with traditional headers 102, 104, and 106, an e-mail address or other address identifier can be entered into field 140. Unlike the traditional fields, however, co-author field 140 can define one or more additional users that will be indicated as an author/sender upon receipt of the e-mail (e.g., when the e-mail is placed for viewing or opening in a recipient's Inbox or the like).

FIG. 2B illustrates that upon receipt, it appears that the e-mail is coming from both Jane Roe and John Doe. Header 120 identifies both names (or addresses or other identifiers). FIG. 2B illustrates what a recipient may see in his or her Inbox upon receipt.

Additionally, FIG. 2B illustrates what Jane Roe and/or John Doe see in their Sent or other e-mail folder. In particular, although Jane Roe may be the user to actually click “Send” to send the e-mail, a copy of the message can be delivered to John Doe's e-mail Inbox and/or to his Sent folder, further attributing the message as originating from him as well as from Jane Roe.

FIG. 2C illustrates how the message may appear after opening it or otherwise viewing it from an Inbox or other folder. In the From header, both Jane Roe and John Doe are identified.

FIG. 2D illustrates a flowchart for processes for co-authored e-mails. In step 210, an e-mail recipient is identified in a first header field. In a preferred embodiment, this step entails entering one or more e-mail addresses or shorthand designations into appropriate header fields. For example, this step may entail typing an e-mail address into a “To” field.

In step 212, an e-mail co-author is identified in a second header field. In a preferred embodiment, this step entails entering one or more e-mail addresses or shorthand designations into a header field that indicates a co-author. In preferred embodiments, this header field is a separate field. However, in alternative embodiments an existing header field can act as a separate header field through appropriate action by a user. For example, an e-mail address or shorthand designation in a “To” field may be “right-clicked” or otherwise selected and tagged as a co-author instead of a simple recipient. In such an embodiment, the “To” field is, in effect, transformed into a second header field (for the particular e-mail address or shorthand designation that was selected) that identifies a co-author.

In step 214, an e-mail message is generated. In a preferred embodiment, this step entails typing or otherwise entering a message. This step may also entail attaching one or more files (which, in one embodiment, may be managed according to techniques of this disclosure).

In step 216, the e-mail message is sent first to the co-author, and then to the recipient in step 222. In alternative embodiments, a message may be sent to the co-author simultaneously or after the recipient. In still other embodiments, the co-author may not be a recipient of the e-mail at all. In such embodiments, while the co-author is indicated in the message, he or she may be unaware of its transmission. Such an embodiment may be preferable for a husband/wife who can send co-authored e-mails without necessarily needing the other's approval (or even knowledge) of the message.

In step 224, the co-author is identified in a header as an additional sender of the e-mail message upon receipt. As in the preferred embodiments of FIGS. 2B-2C, the header can simply be a “From” header. In other embodiments, a different header, such as a “Co-Author” header can be used. In still other embodiments, a recipient in a “To,” and/or “Cc” header may be indicated as a co-author using a different color or other indication.

In different embodiments shown also in FIG. 2D, John Doe can serve different roles as a co-author of the e-mail. In step 218, John Doe may approve the e-mail message prior to sending to the recipients. For example, Jane Roe can compose an e-mail 15 message, enter John Doe as a co-author, and click “Send.” The message can then be delivered to John Doe and not to the listed recipients. The message received by John Doe can indicate (in the body or otherwise) that he has been listed as a co-author and that his approval is requested.

In one embodiment, the e-mail message sent to John Doe for co-authorship approval is “read only.” John Doe can review the e-mail message, including recipient names and one or more attachments, and can decide if he accepts being considered a co-author (as written). John Doe can accept the role of co-author by clicking a button indicating acceptance. Upon acceptance, the e-mail can be sent, and that e-mail will indicate the message as coming from both Jane Roe and John Doe as described earlier. An acceptance/sent confirmation can be relayed to Jane Roe so that she knows that John Doe approved the message and that it was sent. Alternatively, upon acceptance, a confirmation can be sent to Jane Roe, who can then send the message herself.

If Jane Roe modifies e-mail message that has already been approved, the revised message can be sent to John Doe to begin the approval process again prior to sending. Numerous additional logistic approaches can be taken once the e-mail message is approved, as will be understood by those of ordinary skill in the art.

Provisions can be made in case John Doe does not timely offer his approval of the co-authored e-mail. For example, if a co-author does not approve a message within a given amount of time, the author may be sent a notice. At that time, the author may choose to remove the co-author and send the message himself/herself. Alternatively, in the absence of approval after a set amount of time, a message can be automatically sent without the co-author being listed.

In some embodiments, a pre-approval arrangement can dictate that a co-authored e-mail may be sent without any approval or if approval is not provided in a predetermined amount of time. For example, such an arrangement may be appropriate for a boss/employee or wife/husband relationship.

In still other embodiments, as mentioned previously, a co-authored e-mail may be generated and sent directly to recipients, being co-delivered to a co-author or not to the co-author at all.

Those of ordinary skill in the art will be familiar with other techniques for dealing with electronic approval procedures among various users, and any such techniques can be applied to the techniques of this disclosure, which allow for the functionality of co-authored e-mails.

In other embodiments, shown in FIG. 2D, John Doe can be given an opportunity to revise the co-authored e-mail prior to it being sent. Step 220 provides for this functionality. Where revisions are allowed, John Doe can receive an e-mail message for which he is indicated as a co-author and can make one or more changes to that message. In one embodiment, the revised e-mail may then be sent to the recipients. In another embodiment, the revised e-mail may be sent to Jane Roe for approval (followed by sending) or further revision. If further revisions are entered, John Doe may once again approve and/or revise the message. Numerous additional logistic approaches can be taken to achieve such a revision process, as will be understood by those of ordinary skill in the art. Likewise, when there are several co-authors indicated, steps 220 may entail additional management steps to ensure that the multiple co-authors may enter revisions together to arrive at a single, acceptable e-mail. Any techniques for group editing of a document or similar functionality may be employed to this end.

Steps of FIG. 2D and any step of this disclosure can be implemented through appropriate computer software, such as an e-mail application. The application may be integrated with other applications such as calendar functions, reminder lists, and the like. The application may be internet-based or for individual personal computers.

Management of E-Mail Attachments:

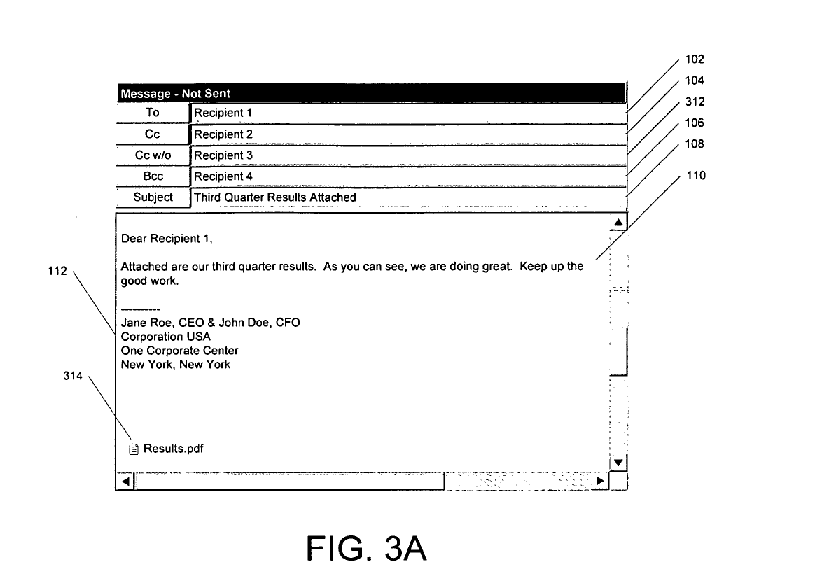

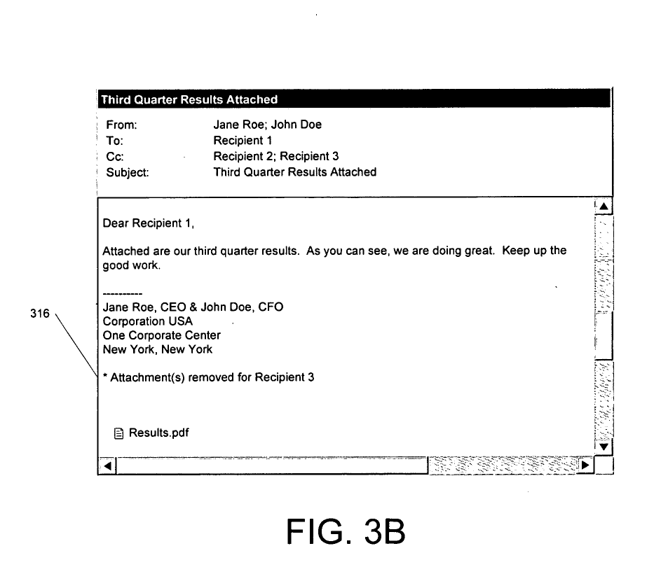

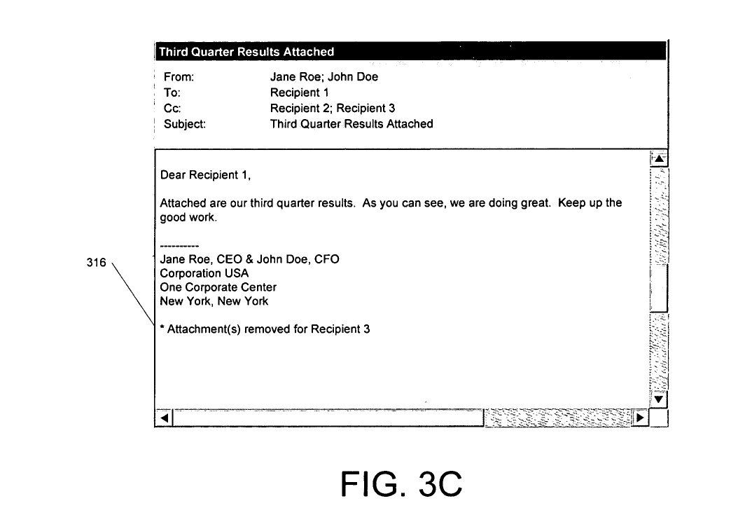

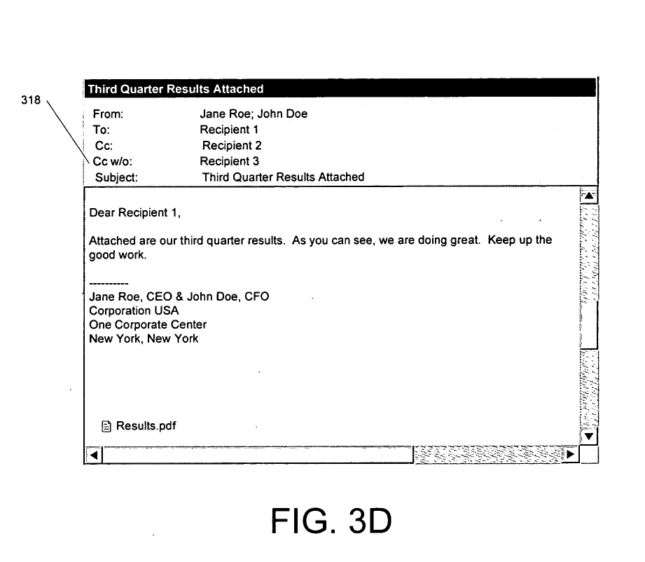

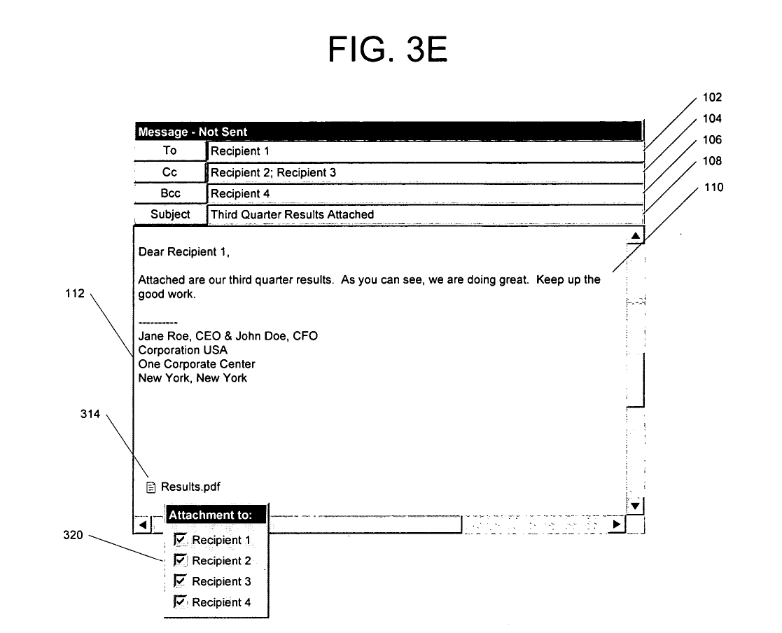

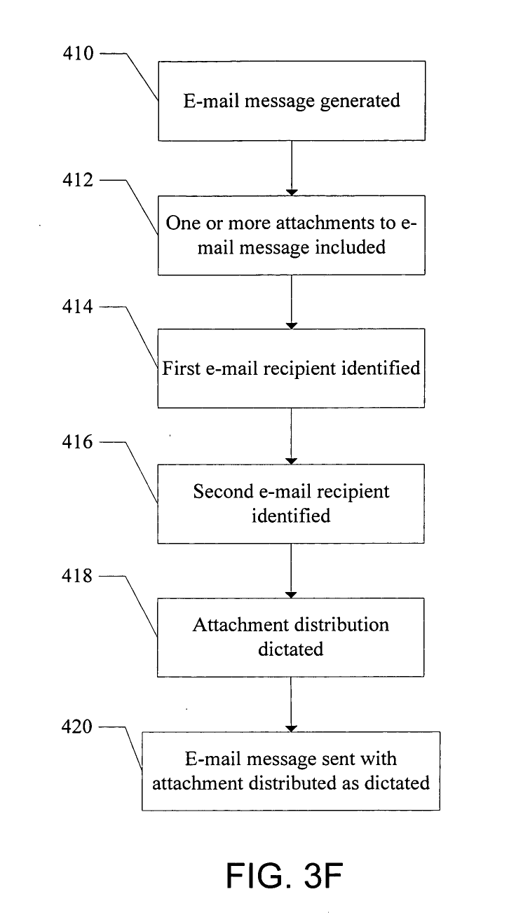

FIGS. 3A-3F are diagrams in accordance with embodiments of the present disclosure dealing with the management of e-mail attachments.

The embodiment of FIG. 3A, and other embodiments concerning distributing of e-mail attachments, allows e-mail messages to be sent with a “Cc without enclosures” feature that is often used for regular mail. In FIG. 3A, a “Cc Without Attachments” header field 312 is provided to identify one or more recipients of an e-mail message who will not receive attachments corresponding to the message. In the embodiment of FIG. 3A, Jane Roe and John Doe are sending the e-mail message 110, using one or more of the embodiments above concerning co-authored e-mails. The e-mail message 110 is intended for Recipient 1 (“To” header field 102), Recipient 2 (“Cc” header field 104), Recipient 3 (“Cc Without Attachments” header field 106), and Recipient 4 (“Bcc” header field 108). Accordingly, Jane Roe and John Doe intend for Recipients 1-4 to receive e-mail message 110 and recipients 1, 2, and 4 to receive attachment 314, which in this embodiment is the file entitled, “Results.pdf.”

FIG. 3B shows an embodiment of the e-mail of FIG. 3A as it is received by Recipients 1, 2, and 4. Recipients 1, 2, and 4 receive attachment 314. These recipients also receive an indication 316 informing them that one or more attachments have been removed for one or more recipients. The content and format of indication 316 may vary in different embodiments. In the embodiment of FIG. 3B, indication 316 identifies Recipient 3 as not receiving attachment 314. A purpose of indication 316 is to notify one or more recipients of attachment distribution so that there is no confusion about who did and did not receive attachment(s).

FIG. 3C shows the e-mail of FIG. 3A as it is received by Recipient 3. Recipient 3 is notified that he or she should not have received attachment 314 by indication 316. Therefore, Recipient 3 will not believe that attachment 314 was inadvertently forgotten—he or she will understand that the e-mail attachment was deliberately left-off the message.

FIG. 3D shows the e-mail of FIG. 3A as it is received by Recipients 1, 2, and 4 according to a different embodiment. Here, Recipient 3 (and the other recipients) is notified that he or she should not have received attachment 314 by way of header field 318. Header field 318 indicates which recipients will not receive one or more attachments. As with the embodiment of FIG. 3C, Recipient 3 will not believe that attachment 314 was inadvertently forgotten.

FIG. 3E illustrates another embodiment for dictating the distribution of attachments among recipients of a single e-mail message. In FIG. 3E, a user may generate the shown e-mail message by filling-in the shown fields and typing the e-mail message. One or more attachments may be added according to methods known in the art. In FIG. 3E, there is only one attachment-attachment 314. Each attachment may be “right-clicked” or otherwise selected to dictate distribution of the attachment. In FIG. 3E, right-clicking attachment 314 brings up window 320. Window 320 lists intended recipients of the e-mail and allows the selection (here, with check-boxes) of which recipient(s) should receive the attachment. It will be understood that methods other than window 320 may achieve the same or similar functionality. For example, one or more pull-down menus may provide the same functionality. In the embodiment of FIG. 3E, each recipient will receive attachment 314. In one embodiment, each recipient being selected for receipt of the attachment may be the default setting. In other embodiments, all “Bcc” recipients may be initially unchecked for attachment receipt. In other embodiments, all “Cc” recipients may be initially unchecked for attachment receipt.

In still other embodiments, e-mail addresses may be pre-defined for attachment receipt or not, for instance, in a “Contacts” folder or “Contacts” setting. For example, Recipient 1's contact information may include a box signifying that he or she should, in a default setting, receive or not receive attachments. In legal settings, this functionality may allow for a secretary to be Cc'd or Bcc'd without normally receiving any attachments. If an attachment is desired, the particular attachment may be right-clicked and the default setting for the secretary may be overridden by checking a box so that he or she receives the attachment.

FIG. 3F illustrates a flowchart for distribution of attachments. In step 410, an e-mail message is generated. In step 412, one or more attachments to the e-mail message are included. In steps 414 and 416, first and second e-mail recipients are identified. This step typically entails entering addresses into one or more header fields such as the “To,” “Cc,” and/or “Bcc” fields. In step 418, a user dictates the distribution of the one or more attachments. This may be done, in one embodiment, as illustrated in FIG. 3E, where each attachment may be selected and the distribution be selected using check boxes. In step 420, the e-mail message is sent, and the attachments are distributed as dictated by the user in step 418. In one embodiment, an attachment may be delivered to the first e-mail recipient but not to the second e-mail recipient.

In different embodiments, attachments included in an e-mail message but not intended for one or more recipients may be stripped from the message in various ways, as will be understood by those of ordinary skill in the art. In one embodiment, an attachment may be removed from an e-mail prior to being sent from a sender. In another embodiment, an attachment may be removed after being sent from a sender but before being opened by a recipient. As with other illustrated embodiments, an indication to one or more recipients may be included to signify the distribution of attachments.

With the benefit of the present disclosure, those having ordinary skill in the art will comprehend that techniques claimed here and described above may be modified and applied to a number of additional, different applications, achieving the same or a similar result. The claims cover all modifications that fall within the scope and spirit of this disclosure.

1. An e-mail method comprising providing a header field to identify a co-author of an e-mail message, the co-author being identified in a header as an additional sender of the e-mail message upon receipt.

2. An e-mail method comprising:
identifying an e-mail recipient in a first header field;
identifying an e-mail co-author in a second header field;
generating an e-mail message;
sending the e-mail message first to the co-author and then to the recipient; and
identifying the co-author in a header as an additional sender of the e-mail message upon receipt.

3. The method of claim 2, further comprising allowing the co-author to approve the e-mail message prior to sending to the recipient.

4. The method of claim 2, further comprising allowing the co-author to revise the e-mail message prior to sending to the recipient.

5. The method of claim 4, further comprising allowing an author to approve revisions of the co-author prior to sending to the recipient.

6. An e-mail method comprising:
generating a single e-mail message including an attachment;
identifying a first e-mail recipient;
identifying a second e-mail recipient;
indicating that the attachment should not be delivered to the second e-mail recipient; and
sending the single e-mail message to the first and second e-mail recipients, the attachment being delivered to the first e-mail recipient but not to the second e-mail recipient.

7. The e-mail method of claim 6, the second e-mail recipient being identified in a “Cc” or “Bcc” header field.

8. The e-mail method of claim 6, the attachment being removed from the e-mail intended for the second e-mail recipient prior to being sent from a sender.

9. The e-mail method of claim 6, the attachment being removed from the e-mail intended for the second e-mail recipient after being sent from a sender but before being opened by the second e-mail recipient.

10. The e-mail method of claim 6, further comprising indicating to the second e-mail recipient that an attachment was not delivered to him or her.

11. The e-mail method of claim 10, further comprising indicating to the first e-mail recipient that an attachment was not delivered to the second e-mail recipient.
